(19) United States
(12) Patent Application Publication
(10) Pub. No.: US 2019/0234468 A1
(43) Pub. Date: Aug. 1, 2019

(54) POWER TRANSMISSION APPARATUS

(71) Applicant: TOYOTA JIDOSHA KABUSHIKI KAISHA, Toyota-shi (JP)

(72) Inventor: Takeshi MINOOKA, Toyota-shi (JP)

(73) Assignee: TOYOTA JIDOSHA KABUSHIKI KAISHA, Toyota-shi (JP)

(21) Appl. No.: 16/261,972

(22) Filed: Jan. 30, 2019

(30) Foreign Application Priority Data
Feb. 1, 2018 (JP) 2018-016771

(51) Int. Cl. F16D 25/0638; F16D 25/10; F16H 63/30

(52) U.S. Cl. CPC F16D 25/0638; F16H 3/663; F16H 63/3026; F16D 25/10

(57) ABSTRACT

A power transmission apparatus includes a friction engagement device in which a piston receiving a hydraulic pressure in an oil chamber moves to a side in which friction plates and plates are to be pressed. When a piston stroke amount is equal to or smaller than a specified amount, a cylindrical surface and the piston cylindrical surface oppose each other in a radial direction, and a first pressure-receiving surface receives the hydraulic pressure of the oil chamber. When the piston stroke amount is larger than the specified amount, the cylindrical surface and the piston cylindrical surface do not oppose each other in the radial direction, and the first pressure-receiving surface and second pressure-receiving surface receive the hydraulic pressure of the oil chamber.

### INCORPORATION BY REFERENCE

The disclosure of Japanese Patent Application No. 2018-016771 filed on Feb. 1, 2018 including the specification, drawings and abstract is incorporated herein by reference in its entirety.

### BACKGROUND

### 1. Technical Field

The disclosure relates to a power transmission apparatus.

### 2. Description of Related Art

In Japanese Patent Application Publication No. 2008-025677 (JP 2008-025677 A), it is disclosed that, as a power transmission apparatus for a vehicle, an automatic transmission capable of establishing any of plural gear shift stages having different gear shift ratios from each other by selectively engaging plural friction engagement devices is mounted. Each of these friction engagement devices is configured to include: a piston that presses a friction plate when receiving a hydraulic pressure in an oil chamber; a holding member that holds the piston in such a manner as to allow movement of the piston; and the oil chamber that is defined by the piston and the holding member.

### SUMMARY

As in the configuration disclosed in JP 2008-025677 A, in the friction engagement device having a conventional structure, a change in a piston stroke amount with respect to a change in the hydraulic pressure of the oil chamber is significant. Thus, it is difficult to slightly change a piston position to such extent that a clearance between friction members is slightly reduced, for example.

The disclosure has been made in view of the above circumstance and therefore has a purpose of providing a power transmission apparatus having a structure capable of slightly changing a piston position of a friction engagement device by a hydraulic pressure.

The present disclosure relates to a power transmission apparatus including a friction engagement device that has: a piston pressing plural friction plates and plural plates; a holding member holding the piston in such a manner as to allow the piston to move relative to the holding member in an axial direction; an oil chamber defined by the holding member and the piston; and a supply port through which hydraulic oil is supplied to the oil chamber. The piston that has received the hydraulic pressure in the oil chamber moves to a side on which the friction plates and the plates are to be pressed in the axial direction. The holding member has a holding-side cylindrical surface extending along a movement direction of the piston. The piston has a piston cylindrical surface extending along the movement direction of the piston. The piston cylindrical surface partitions a pressure-receiving surface receiving the hydraulic pressure of the oil chamber into a first pressure-receiving surface on a radially inner side and a second pressure-receiving surface on a radially outer side in the piston. When a stroke amount of the piston is equal to or smaller than a specified amount, the holding-side cylindrical surface and the piston cylindrical surface oppose each other in a radial direction, and the first pressure-receiving surface on the supply port side of the piston cylindrical surface receives the hydraulic pressure of the oil chamber. When the stroke amount of the piston is larger than the specified amount, the holding-side cylindrical surface and the piston cylindrical surface do not oppose each other in the radial direction, and the first pressure-receiving surface and the second pressure-receiving surface receive the hydraulic pressure of the oil chamber.

According to this configuration, when the stroke amount of the piston is equal to or smaller than the specified amount, only the first pressure-receiving surface receives the hydraulic pressure of the oil chamber. Meanwhile, when the stroke amount of the piston is larger than the specified amount, in addition to the first pressure-receiving surface, the second pressure-receiving surface also receives the hydraulic pressure of the oil chamber. Accordingly, sensitivity of the stroke to a change in the hydraulic pressure can be changed in accordance with the stoke amount of the piston. In the case where only the first pressure-receiving surface receives the hydraulic pressure of the oil chamber, the sensitivity of the stroke to the change in the hydraulic pressure is low. Therefore, a piston position can slightly be changed by hydraulic pressure control.

When the stroke amount of the piston is equal to or smaller than the specified amount, the holding-side cylindrical surface and the piston cylindrical surface may contact each other, the oil chamber may be partitioned into a first oil chamber including the first pressure-receiving surface and a second oil chamber including the second pressure-receiving surface, and the hydraulic pressure may only be supplied to the first oil chamber. When the stroke amount of the piston is larger than the specified amount, the holding-side cylindrical surface and the piston cylindrical surface may not contact each other, and the first oil chamber and the second oil chamber may communicate with each other.

According to this configuration, in the case where the stroke amount of the piston is equal to or smaller than the specified amount, the piston position can be changed only by the hydraulic pressure in the first oil chamber. The hydraulic pressure in the oil chamber is smaller when the hydraulic oil is supplied only to the first oil chamber than when the hydraulic oil is supplied to both the first oil chamber and the second oil chamber. Accordingly, when the stroke amount of the piston is equal to or smaller than the specified amount, sensitivity of a change in the stroke amount to the change in the hydraulic pressure is low. Therefore, the piston position can slightly be changed by controlling the hydraulic pressure.

When the stroke amount of the piston is equal to or smaller than the specified amount, a radial clearance may be provided between the holding-side cylindrical surface and the piston cylindrical surface, a first oil chamber including the first pressure-receiving surface and a second oil chamber including the second pressure-receiving surface may communicate with each other in the oil chamber in a state having a difference in the hydraulic pressure via the radial clearance, and a hydraulic pressure of the first oil chamber may be higher than a hydraulic pressure of the second oil chamber. When the stroke amount of the piston is larger than the specified amount, the first oil chamber and the second oil chamber may communicate with each other with no difference in the hydraulic pressure.

According to this configuration, even in a structure that the holding-side cylindrical surface and the piston cylindrical surface do not contact each other, the sensitivity of the change in the stroke amount to the change in the hydraulic pressure can be reduced when the stroke amount of the piston is equal to or smaller than the specified amount.

In a case where the stroke amount of the piston is the specified amount, the friction engagement device may be brought into a slightly slipping state where drag torque is generated between the friction plates and the plates.

According to this configuration, until the friction engagement device is brought into the slightly slipping state from the disengaged state where the stroke amount of the piston becomes the specified amount, the piston is moved by the hydraulic pressure received from the first pressure-receiving surface. That is, until the friction engagement device is brought into the slightly slipping state, the sensitivity of the change in the stroke amount to the change in the hydraulic pressure can be reduced.

The power transmission apparatus may further include a stepped automatic transmission capable of establishing any of plural gear shift stages having different gear shift ratios by selectively engaging plural engagement devices. Of the plural engagement devices provided in the automatic transmission, the engagement device that is coupled to a rotary member of an unloaded section not involved in power transmission at the time of establishing a specified gear shift stage may be constructed of the friction engagement device. When the specified gear shift stage is established by the automatic transmission, the stroke amount of the piston may become the specified amount, and the friction engagement device may be brought into the slightly slipping state, the friction engagement device being provided on an unloaded section side of a coupling section where a rotary member of a loaded section involved in the power transmission meshes with the rotary member of the unloaded section.

According to this configuration, the friction engagement device with the structure of switching the pressure-receiving surface in accordance with the stroke amount of the piston can be applied to a gear-shift engagement device of the automatic transmission. In addition, the friction engagement device that is brought into the disengaged state at the time of establishing the specified gear shift stage and thus is not involved in the power transmission is controlled to be in a slightly slipping state. In this way, inertia of the unloaded section not included in a power transmission path can be added to the rotary member of the loaded section that is involved in the power transmission. As a result, torque fluctuation that is transmitted through the power transmission path can be dampened by the inertia.

According to the disclosure, size of the pressure-receiving surface of the friction engagement device can be switched in accordance with the stroke amount of the piston. Accordingly, when the stroke amount of the piston is equal to or smaller than the specified amount, the sensitivity of the change in the stroke amount to the change in the hydraulic pressure is low. Therefore, the piston position can slightly be changed by hydraulic pressure control.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram schematically illustrating a configuration of a vehicle on which a power transmission apparatus in an embodiment is mounted;

FIG. 2 is a skeletal view for illustrating an automatic transmission;

FIG. 3 is a table illustrating engagement devices selectively engaged to set each gear shift stage;

FIG. 4 is a schematic view of the case where a friction engagement device is in a disengaged state;

FIG. 5 is a schematic view of the case where the friction engagement device is in a slightly slipping state;

FIG. 6 is a schematic view of the case where the friction engagement device is in an engaged state;

FIG. 7 is a graph illustrating a relationship between a hydraulic pressure and a piston stroke amount of a hydraulic engagement device; and

FIG. 8 is a graph illustrating a relationship between an engine speed and driveshaft torque fluctuation at a specified gear shift stage.

### DETAILED DESCRIPTION OF EMBODIMENTS

Hereinafter, a specific description will be made on a power transmission apparatus in an embodiment of the disclosure with reference to the drawings. Note that, in all of the drawings referred by the following embodiment, the same or corresponding portions will be denoted by the same reference numerals. In addition, the disclosure is not limited by the embodiment, which will be described below.

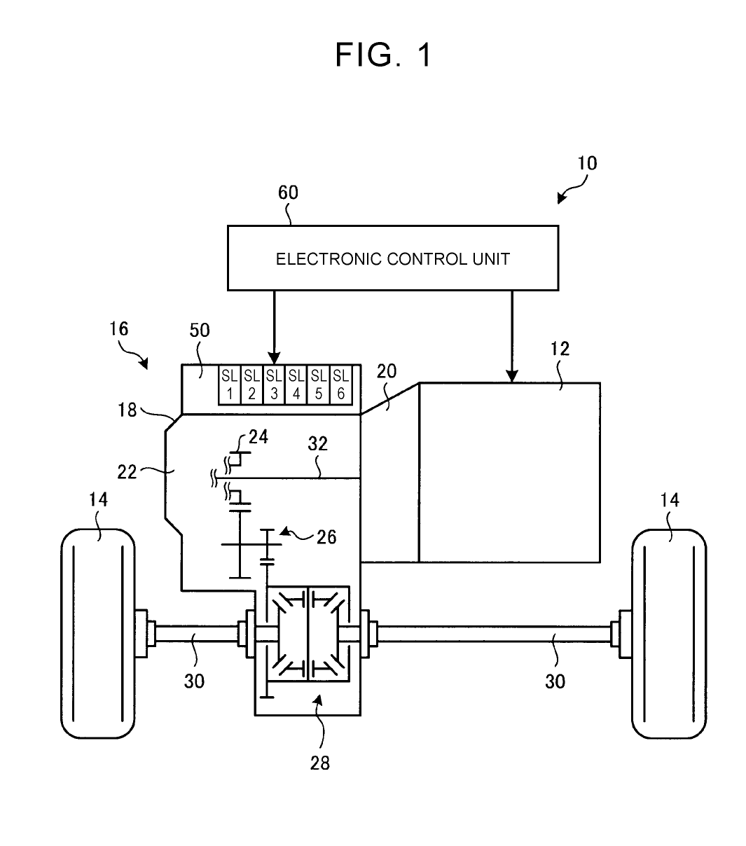

FIG. 1 is a diagram illustrating a schematic configuration of a vehicle on which the power transmission apparatus in the embodiment is mounted. A vehicle 10 includes an engine 12, drive wheels 14, and a power transmission apparatus 16 provided in a power transmission path between the engine 12 and the drive wheels 14. The power transmission apparatus 16 has a case 18 attached to a vehicle body and accommodating: a torque converter 20; an automatic transmission 22; a reduction gear mechanism 26 coupled to an output gear 24 as an output rotary member of the automatic transmission 22; a differential gear 28 coupled to the reduction gear mechanism 26; and driveshafts 30. Power output from the engine 12 is sequentially transmitted to the torque converter 20, the automatic transmission 22, the reduction gear mechanism 26, the differential gear 28, and the driveshafts 30 and eventually transmitted to the drive wheels 14.

The engine 12 is a travel power source and is a known internal combustion engine such as a gasoline engine or a diesel engine. An electronic control unit 60 controls an operation state of the engine 12 including an intake air amount, a fuel supply amount, ignition timing, and the like. A detailed configuration of the electronic control unit 60 will be described below.

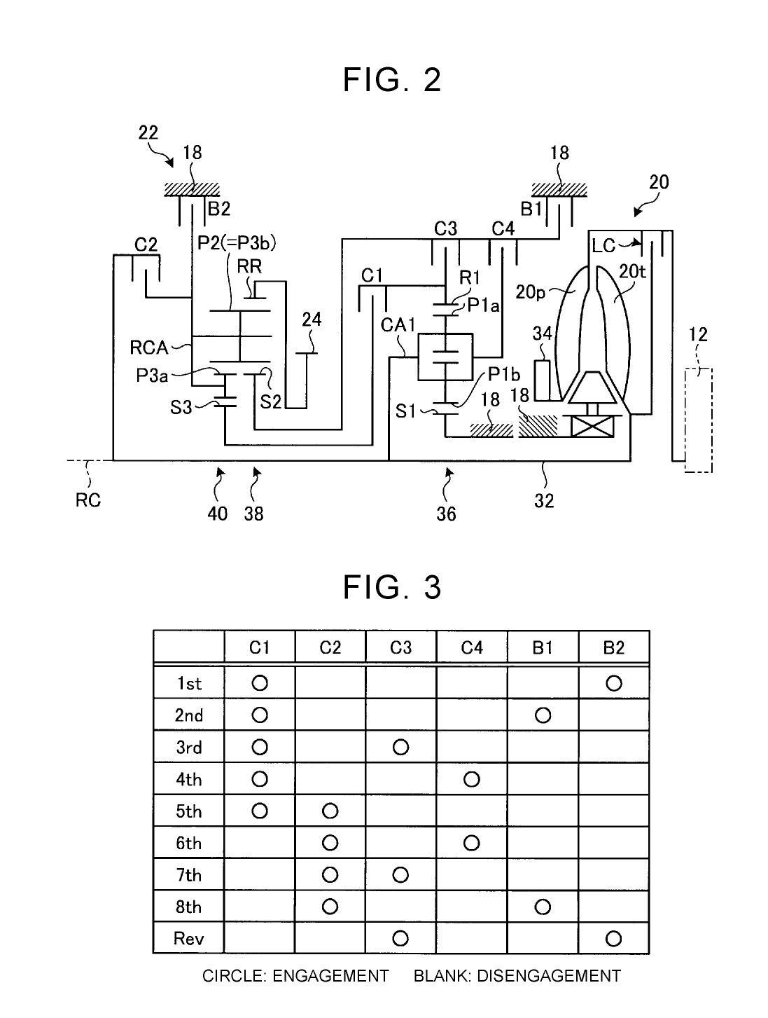

FIG. 2 is a skeletal view for illustrating the automatic transmission 22. The torque converter 20, the automatic transmission 22, and the like are configured to be substantially symmetrical about a shaft center RC of a transmission input shaft 32 as an input rotary member of the automatic transmission 22.

The torque converter 20 is a hydraulic power transmission that is arranged in the power transmission path between the engine 12 and the automatic transmission 22 in such a manner as to rotate about the shaft center RC. As shown in FIG. 2, the torque converter 20 has a pump impeller 20p and a turbine runner 20t. The pump impeller 20p is an input rotary member of the torque converter 20 and is coupled to the engine 12. The turbine runner 20t is an output rotary member of the torque converter 20 and is coupled to the transmission input shaft 32. The transmission input shaft 32 can also be referred to as a turbine shaft. The torque converter 20 further includes a lock-up clutch LC as a direct-coupling clutch that couples the pump impeller 20p and the turbine runner 20t. Meanwhile, the power transmission apparatus 16 includes a mechanical oil pump 34 coupled to the pump impeller 20p. The mechanical oil pump 34 is driven by the engine 12 and discharges hydraulic oil suctioned from an oil pan or the like. The hydraulic oil discharged from the mechanical oil pump 34 is used when gear shift control of the automatic transmission 22 or switching control of an actuation state of the lock-up clutch LC is executed. In addition, the hydraulic oil discharged from the mechanical oil pump 34 is supplied as a lubricant to portions of the power transmission apparatus 16 that require lubrication. The mechanical oil pump 34 functions as a hydraulic pressure supply source in a hydraulic pressure control circuit 50.

The automatic transmission 22 is a stepped automatic transmission that constitutes a part of the power transmission path between the engine 12 and the drive wheels 14. As shown in FIG. 2, the automatic transmission 22 is a multistage transmission of a planetary-gear type that has a first planetary-gear system 36 of a double-pinion type, a second planetary-gear system 38 of a single-pinion type, and a third planetary-gear system 40 of the double-pinion type on the same axis (on the shaft center RC). The second planetary-gear system 38 and the third planetary-gear system 40 constitute a Ravigneaux-type planetary-gear system. The first planetary-gear system 36 functions as a first gear shift section (a primary gear shift section). The Ravigneaux-type planetary-gear system described above functions as a second gear shift section (a secondary gear shift section) disposed on a downstream side of the first gear shift section. The automatic transmission 22 further includes plural engagement devices such as a first clutch C1, a second clutch C2, a third clutch C3, a fourth clutch C4, a first brake B1, and a second brake B2 (hereinafter simply and collectively referred to as “engagement devices CB” unless otherwise distinguished).

The first planetary-gear system 36 includes: a first sun gear S1; plural pairs of first pinion gears P1a, P1b, each pair of the first pinion gears P1a, P1b meshing with each other; a first carrier CA1 that supports the first pinion gears P1a, P1b in such a manner as to allow rotation and revolution thereof; and a first ring gear R1 that meshes with the first sun gear S1 via the first pinion gears P1a, P1b. The second planetary-gear system 38 includes: a second sun gear S2; a second pinion gear P2; a carrier RCA that supports the second pinion gear P2 in such a manner as to allow rotation and revolution thereof; and a ring gear RR that meshes with the second sun gear S2 via the second pinion gear P2. The third planetary-gear system 40 includes: a third sun gear S3; plural pairs of third pinion gears P3a, P3b, each pair of the third pinion gears P3a, P3b meshing with each other; the carrier RCA that supports the third pinion gears P3a, P3b in such a manner as to allow rotation and revolution thereof; and the ring gear RR that meshes with the third sun gear S3 via the third pinion gears P3a, P3b. The third pinion gear P3b and the second pinion gear P2, which constitute a long pinion gear, are shared among the second planetary-gear system 38 and the third planetary-gear system 40 of the Ravigneaux-type planetary-gear system. The carrier RCA and the ring gear RR are also shared among the second planetary-gear system 38 and the third planetary-gear system 40 of the Ravigneaux-type planetary-gear system.

The engagement devices CB are hydraulic friction engagement devices and are each constructed of multiplate wet clutch or multiplate wet brake configured to be pressed by a hydraulic actuator. An actuation state of each of the engagement devices CB is switched when torque capacity thereof varies in accordance with the hydraulic pressure that is an engagement pressure output from corresponding one of plural solenoid valves SL1 to SL6 and the like provided in the hydraulic pressure control circuit 50. In the automatic transmission 22, rotary elements of the planetary-gear systems 36, 38, 40 are engaged or disengaged by the engagement devices CB or are selectively fixed by the engagement devices CB.

In detail, the first sun gear S1 is coupled to the case 18. The first carrier CA1 is coupled to the transmission input shaft 32. The first carrier CA1 and the second sun gear S2 are selectively coupled via the fourth clutch C4. The first ring gear R1 and the third sun gear S3 are selectively coupled via the first clutch C1. The second sun gear S2 is selectively coupled to the case 18 via the first brake B1. The carrier RCA is selectively coupled to the transmission input shaft 32 via the second clutch C2. Furthermore, the carrier RCA is selectively coupled to the case 18 via the second brake B2. The ring gear RR is coupled to the output gear 24.

The automatic transmission 22 is the stepped transmission that selectively sets any of plural gear shift stages having different gear shift ratios γ from each other when the electronic control unit 60 selectively engages some of the engagement devices CB in accordance with an accelerator operation by a driver, a vehicle speed, and the like. For example, as in an engagement actuation table shown in FIG. 3, the automatic transmission 22 selectively sets any of gear stages (any of the gear shift stages) including eight forward gear stages of a first gear stage “1st” to an eighth gear stage “8th” and a reverse gear stage “Rev”. The gear shift ratio γ of the automatic transmission 22 that corresponds to each of the gear shift stages is appropriately determined by a gear ratio (=the number of teeth of the sun gear/the number of teeth of the ring gear) of each of the first planetary-gear system 36, the second planetary-gear system 38, and the third planetary-gear system 40. The gear shift ratio γ is the highest at the first gear stage “1st”, and the gear shift ratio γ is reduced toward the high vehicle speed side (the eighth gear stage “8th” side).

The table shown in FIG. 3 summarizes relationships between the gear shift stages set by the automatic transmission 22 and the actuation states of the engagement devices CB. In FIG. 3, a “circle” represents engagement, and a blank represents disengagement. As shown in FIG. 3, of the forward gear stages, the first gear stage “1st” is established by the engagement of the first clutch C1 and the second brake B2. The second gear stage “2nd” is established by the engagement of the first clutch C1 and the first brake B1. The third gear stage “3rd” is established by the engagement of the first clutch C1 and the third clutch C3. The fourth gear stage “4th” is established by the engagement of the first clutch C1 and the fourth clutch C4. The fifth gear stage “5th” is established by the engagement of the first clutch C1 and the second clutch C2. The sixth gear stage “6th” is established by the engagement of the second clutch C2 and the fourth clutch C4. The seventh gear stage “7th” is established by the engagement of the second clutch C2 and the third clutch C3. The eighth gear stage “8th” is established by the engagement of the second clutch C2 and the first brake B1. In addition, the reverse gear stage “Rev” is established by the engagement of the third clutch C3 and the second brake B2. Furthermore, the automatic transmission 22 is brought into a neutral state when all of the engagement devices CB are disengaged.

Referring back to FIG. 1, the vehicle 10 includes the electronic control unit 60 as a controller that controls the vehicle 10. The electronic control unit 60 is an ECU that is configured to include a microcomputer having a CPU, RAM, ROM, input/output interfaces, and the like, for example.

The electronic control unit 60 receives signals from various sensors and the like that are mounted on the vehicle 10. The various sensors include a vehicle speed sensor, an engine speed sensor, an input rotational speed sensor, an output rotational speed sensor, an accelerator operation amount sensor, a throttle valve opening degree sensor, a brake switch, a shift position sensor, an oil temperature sensor, and the like. The vehicle speed sensor detects the vehicle speed. The engine speed sensor detects an engine speed Ne as a rotational speed of a crankshaft. The input rotational speed sensor detects an AT input rotational speed as a rotational speed of the turbine shaft. The AT input rotational speed is a rotational speed of the transmission input shaft 32 (an input rotational speed of the automatic transmission 22). The output rotational speed sensor detects an AT output rotational speed. The AT output rotational speed is a rotational speed of the output gear 24 (an output rotational speed of the automatic transmission 22). The accelerator operation amount sensor detects an accelerator operation amount as an operation amount of an accelerator pedal. The throttle valve opening degree sensor detects a throttle valve opening degree as an opening degree of an electronic throttle valve. The brake switch detects that a brake operation member used to actuate a wheel brake is operated by the driver. The shift position sensor detects an operation position of a shift lever (a shift position). As the shift positions, “P”, “R”, “N”, “D” and the like are provided. The oil temperature sensor detects a temperature of the hydraulic oil in the hydraulic pressure control circuit 50.

On the basis of the input signals from the various sensors, the electronic control unit 60 executes the gear shift control of the automatic transmission 22, hydraulic pressure control of the hydraulic pressure control circuit 50, and the like so as to control the vehicle 10. The electronic control unit 60 outputs a command signal to each of the devices as control targets that are mounted on the vehicle 10. For example, when controlling the engine 12, the electronic control unit 60 outputs an engine control command signal to the engine 12. When controlling the engagement devices CB, the electronic control unit 60 outputs a hydraulic pressure command signal to the hydraulic pressure control circuit 50, and the hydraulic pressure command signal is used to control the actuation states of the engagement devices CB. The hydraulic pressure command signal is the command signal used to drive the solenoid valves SL1 to SL6, each of which regulates the hydraulic pressure (the engagement pressure) to be supplied to the hydraulic actuator (an oil chamber) of the corresponding engagement device CB. Note that the electronic control unit 60 may be configured to be divided into an engine control ECU, a hydraulic pressure control ECU, and the like in accordance with needs.

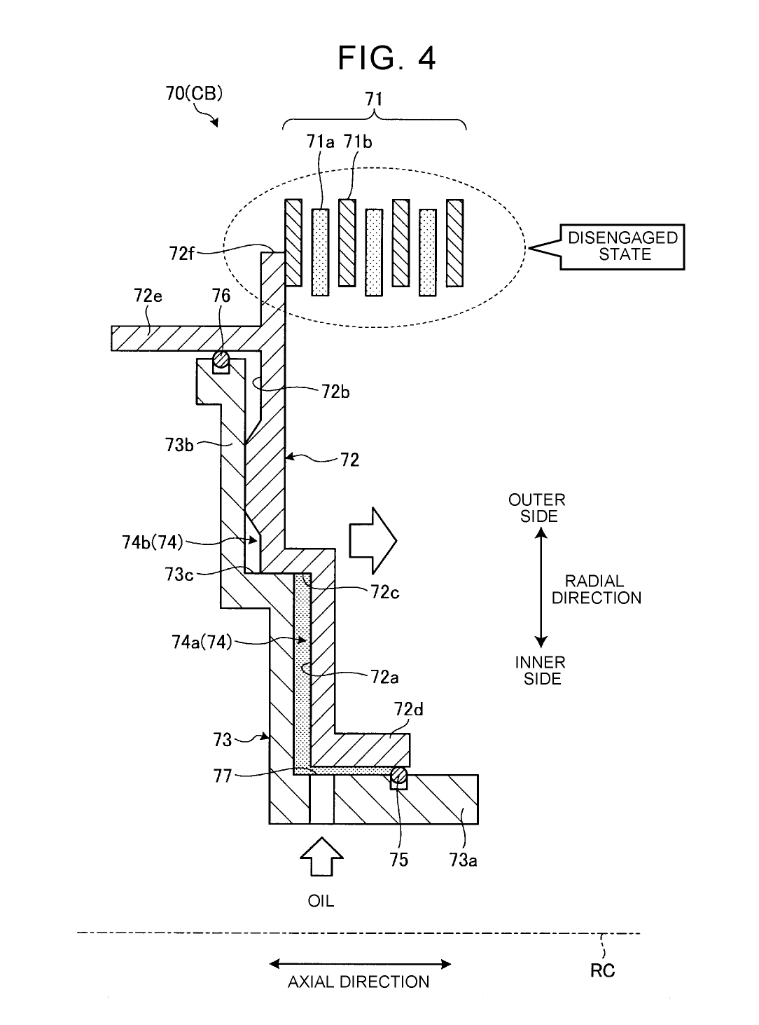

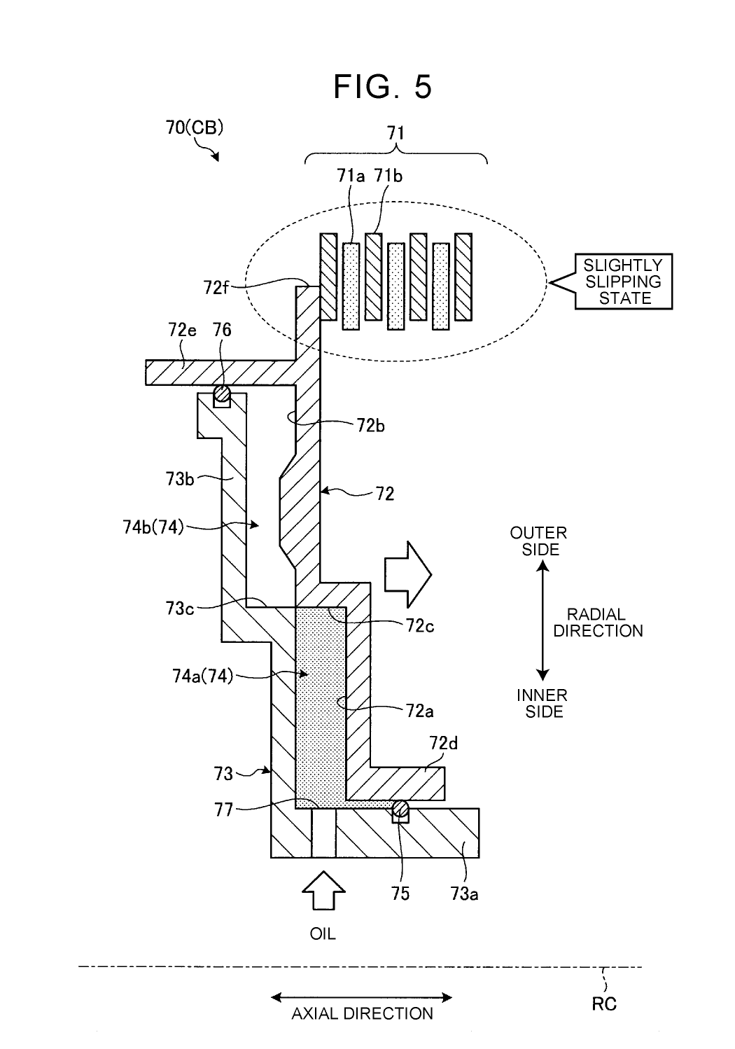

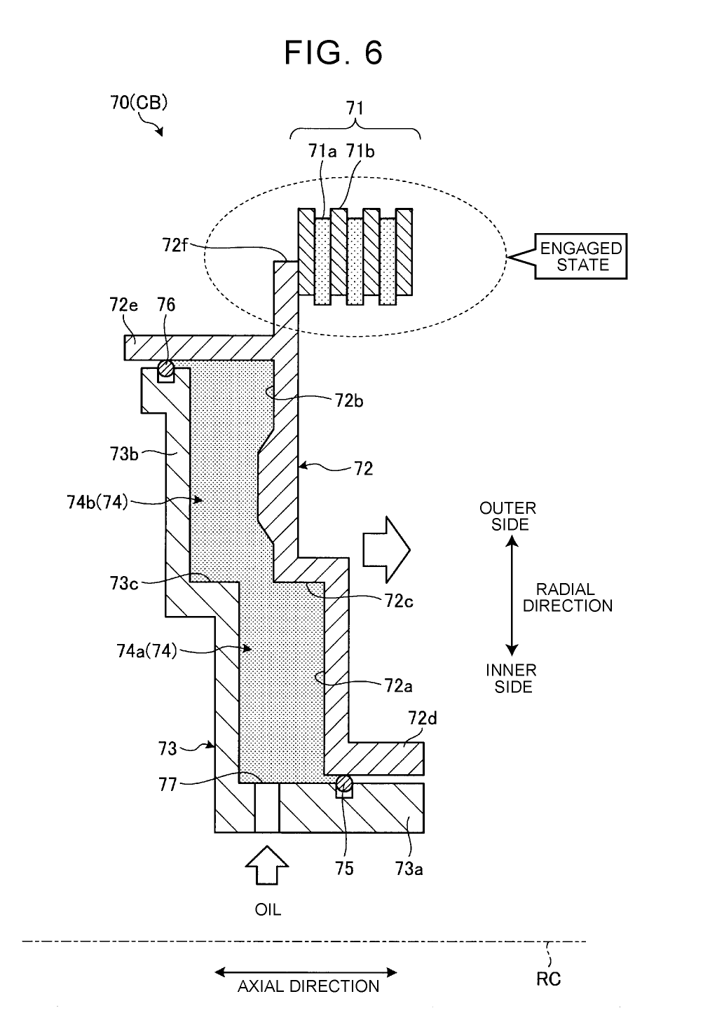

A description will herein be made on a structure of a friction engagement device 70 capable of constituting each of the engagement devices CB with reference to FIG. 4 to FIG. 6. FIG. 4 is a schematic view of the friction engagement device 70 in a disengaged state. FIG. 5 is a schematic view of the friction engagement device 70 in a slightly slipping state. FIG. 6 is a schematic view of the friction engagement device 70 in an engaged state. Note that, in the description, the engagement device CB and the friction engagement device 70 mean the same.

The friction engagement device 70 has friction members 71, a piston 72, a holding member 73, and an oil chamber 74. The friction members 71 are friction engagement elements that are frictionally engaged with each other when being pressed by the piston 72. The piston 72 is a pressing member that moves in an axial direction and presses the friction members 71 when receiving the hydraulic pressure in the oil chamber 74. The holding member 73 is a member that holds the piston 72 in such a manner as to allow mutual movement thereof in the axial direction. The oil chamber 74 is defined by the piston 72 and the holding member 73 and is supplied with the hydraulic pressure from the hydraulic pressure control circuit 50. The oil chamber 74 includes a first oil chamber 74a and a second oil chamber 74b. Note that the friction engagement device 70 is configured to include a return spring (not shown) that presses the piston 72 in a direction to separate the friction members 71.

The friction members 71 include plural friction plates 71a and plural plates 71b, and the friction plates 71a and the plates 71b are alternately arranged in the axial direction. The friction plates 71a and the plates 71b are each formed in a ring shape. For example, in the case where the friction engagement device 70 is the clutch, each of the friction plates 71a is a rotary element whose inner circumference is spline-fitted to an outer circumference of a clutch hub (not shown), and each of the plates 71b is a rotary element whose outer circumference is spline-fitted to an inner circumference of a clutch drum (not shown). Meanwhile, in the case where the friction engagement device 70 is a brake, each of the plates 71b is a fixed element that is fixed to the case 18, and each of the friction plates 71a is a rotary element that is coupled to the rotary member of the automatic transmission 22.

The piston 72 has a first pressure-receiving surface 72a and a second pressure-receiving surface 72b as pressure-receiving surfaces that receive the hydraulic pressure of the oil chamber 74. The first pressure-receiving surface 72a is a surface that receives the hydraulic pressure of the hydraulic oil supplied to the first oil chamber 74a and opposes the holding member 73 in the axial direction. The second pressure-receiving surface 72b is a surface that receives the hydraulic pressure of the hydraulic oil supplied to the second oil chamber 74b. The second pressure-receiving surface 72b opposes the holding member 73 in the axial direction at a position on a radially outer side of the first pressure-receiving surface 72a. The piston 72 is further provided with a piston cylindrical surface 72c that extends along a movement direction of the piston 72 (the axial direction). The piston cylindrical surface 72c is a surface on a side that defines the oil chamber 74. The piston cylindrical surface 72c is continuously formed for an entire circumference of the piston 72, and faces radially inward. The piston 72 has a step structure in the radial direction. The piston cylindrical surface 72c partitions the pressure-receiving surface into the first pressure-receiving surface 72a on a radially inner side and the second pressure-receiving surface 72b on the radially outer side. In other words, the first pressure-receiving surface 72a and the second pressure-receiving surface 72b are connected to each other via the piston cylindrical surface 72c.

Moreover, the piston 72 has: a cylindrical boss section 72d that is held by the holding member 73 on the radially inner side; a large-diameter cylindrical section 72e that is held by the holding member 73 on the radially outer side; and a pressing section 72f that presses the friction members 71. A seal member 75 seals a portion between an inner circumference of the boss section 72d and an outer circumference of the holding member 73. A seal member 76 seals a portion between an inner circumference of the cylindrical section 72e and the outer circumference of the holding member 73. The pressing section 72f is a portion that comes into contact with the friction member 71 (the plate 71b in detail) and applies an axial load (the engagement pressure) by the hydraulic pressure to the friction members 71.

The holding member 73 includes a boss section 73a, a flange section 73b, and a cylindrical surface 73c. The boss section 73a is a small-diameter cylindrical section formed on the radially inner side, and is a portion that holds the boss section 72d of the piston 72. The flange section 73b is a wall section that extends radially outward from one end of the boss section 73a, and is a portion that holds the cylindrical section 72e of the piston 72. The cylindrical surface 73c is formed in a surface of the flange section 73b on a side that defines the oil chamber 74 and extends along the movement direction of the piston 72 (the axial direction). In addition, the cylindrical surface 73c is a holding-side cylindrical surface that is continuously formed for an entire circumference of the holding member 73 and faces radially outward. Just as described, the holding member 73 has the step structure in the radial direction, and the cylindrical surface 73c partitions the surface of the flange section 73b defining the oil chamber 74 into an oil chamber defining surface on the radially inner side (a surface that opposes the first pressure-receiving surface 72a in the axial direction) and an oil chamber defining surface on the radially outer side (a surface that opposes the second pressure-receiving surface 72b in the axial direction).

Furthermore, the cylindrical surface 73c of the holding member 73 and the piston cylindrical surface 72c of the piston 72 oppose each other in the radial direction. In the example shown in FIG. 4, the friction engagement device 70 is in the disengaged state, and the piston cylindrical surface 72c is in contact with the cylindrical surface 73c of the holding member 73. This contact state is maintained until the friction engagement device 70 is shifted from the disengaged state to the slightly slipping state.

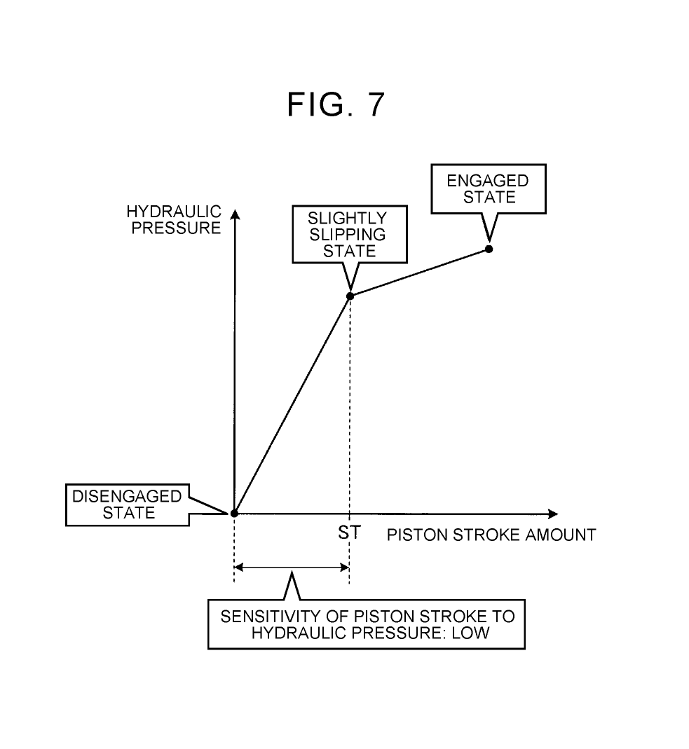

The state of the friction engagement device 70 can be switched among the disengaged state (shown in FIG. 4), the slightly slipping state (shown in FIG. 5), and the engaged state (shown in FIG. 6). In a process in which the state of the friction engagement device 70 is transitioned from the disengaged state to the engaged state, the friction engagement device 70 can be shifted to the slightly slipping state as an intermediate state. The slightly slipping state is a state where drag torque is generated among the friction members 71. As shown in FIG. 7, in the transition process, the state of the friction engagement device 70 is transitioned from the disengaged state (a first state) where the hydraulic pressure is low to the engaged state (a third state) through the slightly slipping state (a second state). In addition, a piston stroke amount is the smallest in the disengaged state, the piston stroke amount is larger in the slightly slipping state than in the disengaged state, and the piston stroke amount is further larger in the engaged state than in the slightly slipping state. Furthermore, until the friction engagement device 70 is shifted from the disengaged state to the slightly slipping state, a change in the piston stroke amount with respect to a change in the hydraulic pressure is small, and thus sensitivity of the piston stroke to the hydraulic pressure is low. Until the friction engagement device 70 is shifted from the slightly slipping state to the engaged state, the change in the piston stroke amount with respect to the change in the hydraulic pressure is large, and thus the sensitivity of the piston stroke to the hydraulic pressure is high. That is, the friction engagement device 70 has such a structure that a degree of the sensitivity of the piston stroke to the change in the hydraulic pressure varies in accordance with the piston stroke amount. Here, the axial direction is a direction in which the shaft center RC of the transmission input shaft 32 extends. The axial direction is the movement direction of the piston 72. The radial direction is a direction perpendicular to the axial direction.

As shown in FIG. 4, because the hydraulic pressure is not supplied to the first oil chamber 74a in the disengaged state, the piston 72 does not move in an engagement direction and thus is located at a disengaged position. Accordingly, the friction plates 71a and the plates 71b are brought into separating state (a state where the friction members 71 separate from each other in the axial direction), and thus the torque cannot be transmitted between the friction plates 71a and the plates 71b. In addition, because the piston cylindrical surface 72c is in contact with the cylindrical surface 73c of the holding member 73, this contact portion partitions the oil chamber 74 into the first oil chamber 74a and the second oil chamber 74b. When the hydraulic pressure is supplied to the first oil chamber 74a in the disengaged state, the friction engagement device 70 is shifted to the slightly slipping state as the intermediate state. When the friction engagement device 70 is shifted from the disengaged state to the slightly slipping state, the piston cylindrical surface 72c slides on the cylindrical surface 73c.

As shown in FIG. 5, in the slightly slipping state, the hydraulic pressure is only supplied to the first oil chamber 74a, and the hydraulic pressure is applied to the first pressure-receiving surface 72a of the piston 72 while the hydraulic pressure not being applied to the second pressure-receiving surface 72b. The piston 72, which receives the hydraulic pressure only from the first pressure-receiving surface 72a, is moved for a specified amount ST (shown in FIG. 7). Accordingly, a space between the friction members 71 is reduced, and the drag torque (friction) is generated between the friction plates 71a and the plates 71b. In a state where such drag torque (friction) is generated, each of the friction plates 71a and corresponding one of the plates 71b do not contact each other and one of the friction members 71 is dragged by the hydraulic oil present between the friction plate 71a and the plates 71b. In addition, in the slightly slipping state, the piston cylindrical surface 72c is in contact with the cylindrical surface 73c. Thus, in the oil chamber 74, only the first oil chamber 74a communicates with a supply port 77. When the hydraulic pressure is further supplied to the first oil chamber 74a in the slightly slipping state, the piston 72 is moved to an engaged position side due to an increase in the hydraulic pressure, and the piston cylindrical surface 72c is made to have no contact with the cylindrical surface 73c. That is, the friction engagement device 70 is shifted to a state where the piston cylindrical surface 72c and the cylindrical surface 73c do not oppose each other in the radial direction. Just as described, the first oil chamber 74a and the second oil chamber 74b communicate with each other, when the contact state (an opposing state) between the piston cylindrical surface 72c and the cylindrical surface 73c is canceled in accordance with the piston position. That is, when the friction engagement device 70 is shifted from the slightly slipping state to the engaged state, the hydraulic pressure is supplied to the single oil chamber 74 in which the first oil chamber 74a and the second oil chamber 74b are combined.

As shown in FIG. 6, in the engaged state, the hydraulic pressure is supplied to the second oil chamber 74b in addition to the first oil chamber 74a, and the hydraulic pressure is applied to the first pressure-receiving surface 72a and the second pressure-receiving surface 72b of the piston 72. Because the piston cylindrical surface 72c and the cylindrical surface 73c separate from each other, the first oil chamber 74a and the second oil chamber 74b communicate with each other with no difference in the hydraulic pressure. Accordingly, the pressure-receiving surface of the piston 72 is a combined surface of the first pressure-receiving surface 72a and the second pressure-receiving surface 72b. In addition, the friction members 71 are in contact with each other, and the friction plates 71a are frictionally engaged with the plates 71b. That is, due to generation of an engagement force, the torque can be transmitted between the friction plates 71a and the plates 71b.

Next, a description will be made on an effect of dampening a torque fluctuation that is transmitted throughout the automatic transmission 22 by controlling the friction engagement device 70 provided in the automatic transmission 22 into the slightly slipping state. At each of the gear shift stages, the automatic transmission 22 includes a loaded section that is a portion involved in power transmission (a portion included in the power transmission path) and an unloaded section that is a portion not involved in the power transmission (a portion not included in the power transmission path). The loaded section and the unloaded section are coupled to each other via a coupling section by spline-fitting, meshing of the gears, and the like. Thus, the rotary member of the unloaded section is rotated by the loaded section. When a specified gear shift stage is established, some of the friction engagement devices of the engagement devices CB are in the disengaged state. Such friction engagement devices in the disengaged state are brought into the slightly slipping state. In this way, backlash that is produced in the coupling section between the loaded section and the unloaded section can be reduced, and inertia of the unloaded section can be added to the loaded section from the coupling section.

For this reason, in a specified operation state, the electronic control unit 60 executes slightly slipping control to supply the hydraulic pressure to the friction engagement device 70 in the disengaged state at the specified gear shift stage of the automatic transmission 22 so as to bring such a friction engagement device 70 into the slightly slipping state. The hydraulic pressure in the slightly slipping control is supplied to the friction engagement device 70 in a range that does not affect the establishment of the specified gear shift stage. Due to the execution of the slightly slipping control, a magnitude of the drag torque generated in the friction engagement device 70 is increased. In this way, the inertia of the unloaded section keeps being applied to the coupling section between the unloaded section and the loaded section in a reverse torque direction of the backlash in a rotational direction. As a result, loss of the inertia of the unloaded section is suppressed, and the inertia of the unloaded section is added to the loaded section.

For example, when the fifth gear stage “5th” is established in the automatic transmission 22, at the fifth gear stage “5th”, the first clutch C1 and the second clutch C2 are engaged with each other, and the third clutch C3, the fourth clutch C4, the first brake B1, and the second brake B2 are disengaged. The second pinion gear P2 that constitutes the loaded section meshes with the second sun gear S2 that constitutes the unloaded section. Via such a meshing section, the unloaded section is rotated in conjunction with rotation of the second pinion gear P2. The rotary member of the loaded section that rotates mutually is the first ring gear R1 and the rotary member of the unloaded section that is rotated mutually is the second sun gear S2, and the target friction engagement device 70 is the third clutch C3 in the disengaged state. When the third clutch C3 is brought into the slightly slipping state, the drag torque (the friction) is generated among the friction members 71. Due to the generation of the friction in the third clutch C3, a load in a direction to eliminate the backlash is applied to the meshing section between the second pinion gear P2 and the second sun gear S2 that is the coupling section between the loaded section and the unloaded section. When the backlash is eliminated in the coupling section between the loaded section and the unloaded section, the inertia of the unloaded section can be added to the loaded section. As a result, even in the case where the torque fluctuation generated in the engine 12 is transmitted to the automatic transmission 22, vibrations can be dampened by adding the inertia of the unloaded section. In addition, when the friction engagement device 70 is brought into the slightly slipping state and thus the inertia of the unloaded section is added to the loaded section, an increase in the load by the inertia of the unloaded section affects fuel economy. Thus, in consideration of states of the vibrations and noise in the power transmission apparatus 16, the friction engagement device 70 is brought into the slightly slipping state only when necessary. In this way, the noise and the vibrations (NV) can be reduced while undesirable degradation of the fuel economy is minimized.

Note that the backlash (a clearance in the rotational direction) is produced between the loaded section and the unloaded section. Such backlash includes all kinds of the backlash in the unloaded section. In addition, since the torque is not transmitted between the loaded section and the unloaded section, the unloaded section is rotated mutually to the loaded section within a range of the backlash. At this time, the unloaded section alternately abuts a portion on a drive side and a portion on a driven side of the loaded section.

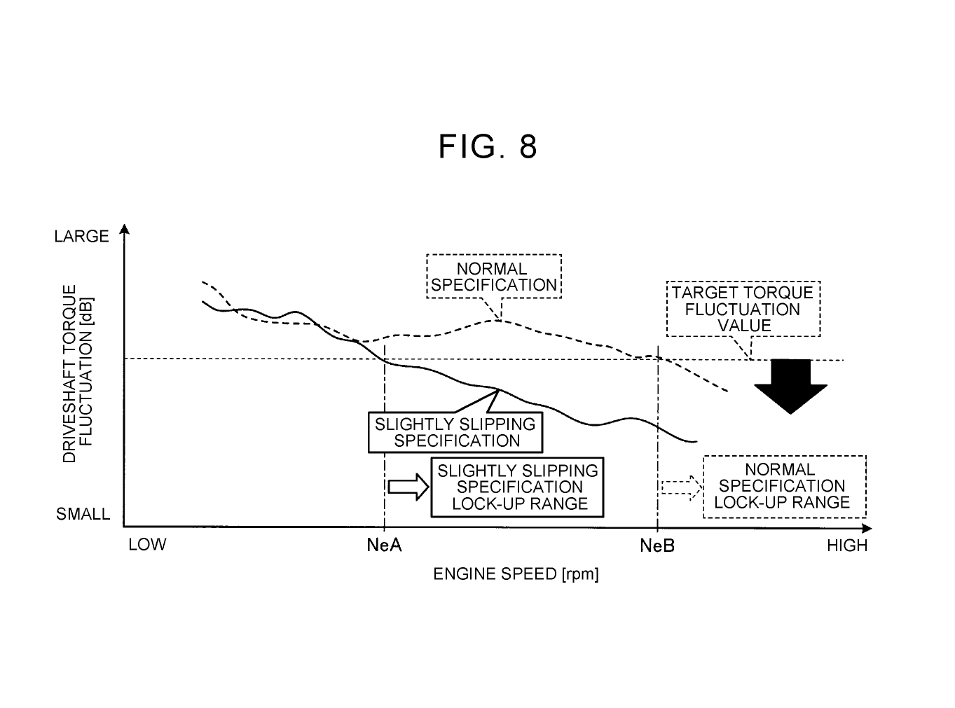

In the vehicle 10, when the lock-up clutch LC is engaged, explosive vibrations of the engine 12 are transmitted to the vehicle body through the driveshafts 30. During the travel with the engaged lock-up clutch LC, the explosive vibrations of the engine 12 are less likely to be dampened, and loud muffled sound is likely to be generated. Thus, a low-speed range where the explosive vibrations of the engine 12 are larger than those in a high-speed range will be referred to as a lock-up off range. A lock-up range can be expanded when the generation of the muffled sound can be suppressed during lock-up travel (see FIG. 8).

FIG. 8 is a graph illustrating a relationship between the engine speed Ne and the torque fluctuation of each of the driveshafts 30 at the specified gear shift stage of the automatic transmission 22. The driveshaft torque fluctuation represents a magnitude of the torque fluctuation in each of the driveshafts 30 at the time when the explosive vibrations of the engine 12 are transmitted thereto. A characteristic of a “normal specification” indicated by a broken line in FIG. 8 represents a change in the driveshaft torque fluctuation during normal time in which the target friction engagement device 70 is not brought into the slightly slipping state. A characteristic of a “slightly slipping specification” indicated by a solid line in FIG. 8 represents the driveshaft torque fluctuation during execution of the control to bring the target friction engagement device 70 into the slightly slipping state. Note that the friction engagement device 70 as the target of the slightly slipping control will be described as a target engagement device.

In the “normal specification”, in a range where the engine speed Ne is lower than a specified first speed NeA, the driveshaft torque fluctuation exceeds a target torque fluctuation value due to the large explosive vibrations of the engine 12. In addition, even when the engine speed Ne becomes higher than the specified first speed NeA, the driveshaft torque fluctuation is not reduced due to a fact that the inertia of the unloaded section is likely to be lost due to the reduced explosive vibrations of the engine 12. Thus, the driveshaft torque fluctuation is not reduced to be equal to or lower than the target torque fluctuation value. In the “normal specification”, when the engine speed Ne becomes equal to or higher than a specified second speed NeB that is higher than the first speed NeA, the explosive vibrations of the engine 12 are further reduced. Thus, even when the loss of the inertia of the unloaded section occurs, the driveshaft torque fluctuation can be reduced to be equal to or smaller than the target torque fluctuation value. The target torque fluctuation value is an upper limit value of the driveshaft torque fluctuation that is predetermined such that the generation of the muffled sound during the lock-up travel does not become problematic, for example. In the “normal specification”, a range of the engine speed Ne that is equal to or higher than the second speed NeB and in which the driveshaft torque fluctuation is equal to or smaller than the target torque fluctuation value is defined as a lock-up execution range.

In the “slightly slipping state”, in the range where the engine speed Ne is lower than the first speed NeA, the explosive vibrations of the engine 12 are originally large. Thus, an effect of the slightly slipping control of the target engagement device is not exerted, and similar to the “normal specification”, the driveshaft torque fluctuation exceeds the target torque fluctuation value. In the “slightly slipping specification”, when the engine speed Ne becomes equal to or higher than the specified first speed NeA, the loss of the inertia of the unloaded section is less likely to occur due to the slightly slipping control of the target engagement device. In this way, the driveshaft torque fluctuation is reduced along with the reduction in the explosive vibrations of the engine 12, and the driveshaft torque fluctuation is reduced to be equal to or smaller than the target torque fluctuation value. In the “slightly slipping specification”, a range of the engine speed Ne that is equal to or higher than the first speed NeA and in which the driveshaft torque fluctuation is equal to or smaller than the target torque fluctuation value is defined as the lock-up execution range. That is, in the “slightly slipping specification”, the lock-up execution range is expanded to a range on a low speed side in comparison with the lock-up execution range in the “normal specification”. In addition, in the range where the engine speed Ne is equal to or higher than the second speed NeB, as indicated by the “normal specification”, the driveshaft torque fluctuation is reduced to be equal to or smaller than the target torque fluctuation value even when the slightly slipping control of the target engagement device is not executed. Accordingly, the slightly slipping control of the target engagement device at least only has to be executed in the specified operation range (speed range) in which the engine speed Ne is equal to or higher than the specified first speed NeA and is lower than the second speed NeB. The specified operation range in which the slightly slipping control of the target engagement device is executed is a range in which the lock-up clutch LC can be engaged due to the effect of the slightly slipping control. That is, the specified operation range is the range in which the lock-up clutch LC cannot be engaged without executing the slightly slipping control of the target engagement device. This is because the generation of the muffled sound is less likely to be suppressed even when the loss of the inertia of the unloaded section is likely to occur due to the reduction in the explosive vibrations of the engine 12. In other words, the specified operation state is the specified speed range of the engine 12 in which the muffled sound, which is associated with the engagement of the lock-up clutch LC, is likely to be generated due to the reduction in the explosive vibrations of the engine 12 associated with the increase in the engine speed Ne.

In addition, in order to appropriately execute the slightly slipping control of the target engagement device, the electronic control unit 60 includes processing sections such as a determination section that determines the operation state and a hydraulic pressure control section that controls the hydraulic pressure to be supplied to the friction engagement device 70. The determination section determines whether the engine speed Ne is equal to or higher than the first speed NeA and lower than the second speed NeB. The hydraulic pressure control section controls the target friction engagement device 70 to be in the slightly slipping state in the case where the determination section determines that the engine speed Ne is in the specified operation range.

As it has been described so far, according to the embodiment, the piston position of the friction engagement device 70 can slightly be changed by controlling the hydraulic pressure. In this way, in the friction engagement device 70, the friction (the drag torque) can be generated among the friction members 71.

In the friction engagement device 70, the two oil chambers 74a, 74b can be defined by the single piston 72. That is, since the plural pistons are unnecessary, the friction engagement device 70 can have a simple structure.

Furthermore, when the specified gear shift stage is established, the target friction engagement device 70 is brought into the slightly slipping state. Accordingly, the inertia of the unloaded section, which is not involved in the power transmission, can be added to the loaded section. As a result, the vibrations (the torque fluctuation) transmitted to the loaded section by the inertia of the unloaded section can be dampened. Thus, the vibrations and the noise can be reduced. In this way, NV reduction performance can be improved while degradation of efficiency of the power transmission apparatus 16 is minimized.

Note that the friction engagement device 70 need not be the clutch but may be the brake. Furthermore, the holding member 73 of the friction engagement device 70 may be the so-called clutch drum.

As a modified example of the above-described embodiment, the friction engagement device 70 may have a structure that the piston cylindrical surface 72c does not contact the cylindrical surface 73c. In this modified example, the friction engagement device 70 has such a structure that, even when the piston 72 moves toward the engaged position, the piston cylindrical surface 72c does not slide on the cylindrical surface 73c. More specifically, in the friction engagement device 70 of the modified example, in the disengaged state and the slightly slipping state, the piston cylindrical surface 72c and the cylindrical surface 73c oppose each other and has a radial clearance therebetween. The radial clearance between the piston cylindrical surface 72c and the cylindrical surface 73c is formed as a clearance (a narrow clearance) where significant loss of the hydraulic pressure of the first oil chamber 74a occurs in the case where the hydraulic pressure is supplied to the first oil chamber 74a (in the transition state from the disengaged state to the slightly slipping state), for example. Accordingly, until the friction engagement device 70 is shifted from the disengaged state to the slightly slipping state, the piston 72 is moved mainly by the hydraulic pressure of the first oil chamber 74a. For this reason, even in the case where the hydraulic oil that is supplied from the supply port 77 to the first oil chamber 74a flows into the second oil chamber 74b via the first oil chamber 74a and the above-described radial clearance, the hydraulic pressure that affects the piston stroke is not generated in the second oil chamber 74b until the friction engagement device 70 is shifted from the disengaged state to the slightly slipping state. Even in the case where the hydraulic pressure is generated in the second oil chamber 74b in the state where the piston cylindrical surface 72c and the cylindrical surface 73c oppose each other, a magnitude of such a hydraulic pressure is extremely smaller than the hydraulic pressure of the first oil chamber 74a. In this modified example, when the piston stroke amount is equal to or smaller than the specified amount ST, the piston cylindrical surface 72c and the cylindrical surface 73c oppose each other in the radial direction, and the first oil chamber 74a and the second oil chamber 74b communicate with each other with the difference in the hydraulic pressure. Meanwhile, when the piston stroke amount is larger than the specified amount ST, the piston cylindrical surface 72c and the cylindrical surface 73c no longer oppose each other in the radial direction, and the first oil chamber 74a and the second oil chamber 74b communicate with each other with no difference in the hydraulic pressure. Just as described, as long as the desired hydraulic pressure difference can be set between the first oil chamber 74a and the second oil chamber 74b until shifting from the disengaged state to the slightly slipping state, such a structure that the piston cylindrical surface 72c and the cylindrical surface 73c do not contact each other may be adopted.

What is claimed is:

1. A power transmission apparatus comprising:
a friction engagement device including
a piston configured to press plural friction plates and plural plates,
a holding member that holds the piston in such a manner as to allow the piston to move relatively to the holding member in an axial direction,
an oil chamber defined by the holding member and the piston, and
a supply port through which hydraulic oil is supplied to the oil chamber, wherein
the piston that has received a hydraulic pressure in the oil chamber moves to a side on which the friction plates and the plates are to be pressed in the axial direction,
the holding member has a holding-side cylindrical surface extending along a movement direction of the piston,
the piston has a piston cylindrical surface extending along the movement direction of the piston and a pressure-receiving surface receiving the hydraulic pressure of the oil chamber, and the piston cylindrical surface partitions the pressure-receiving surface into a first pressure-receiving surface on a radially inner side and a second pressure-receiving surface on a radially outer side,
when a stroke amount of the piston is equal to or smaller than a specified amount, the holding-side cylindrical surface and the piston cylindrical surface oppose each other in a radial direction, and the first pressure-receiving surface on a supply port side of the piston cylindrical surface receives the hydraulic pressure of the oil chamber, and
when the stroke amount of the piston is larger than the specified amount, the holding-side cylindrical surface and the piston cylindrical surface do not oppose each other in the radial direction, and the first pressure-receiving surface and the second pressure-receiving surface receive the hydraulic pressure of the oil chamber.

2. The power transmission apparatus according to claim 1, wherein
when the stroke amount of the piston is equal to or smaller than the specified amount, the holding-side cylindrical surface and the piston cylindrical surface contact each other, the oil chamber is partitioned into a first oil chamber including the first pressure-receiving surface and a second oil chamber including the second pressure-receiving surface, and the hydraulic pressure is only supplied to the first oil chamber, and
when the stroke amount of the piston is larger than the specified amount, the holding-side cylindrical surface and the piston cylindrical surface do not contact each other, and the first oil chamber and the second oil chamber communicate with each other.

3. The power transmission apparatus according to claim 1, wherein
when the stroke amount of the piston is equal to or smaller than the specified amount, a radial clearance is provided between the holding-side cylindrical surface and the piston cylindrical surface, a first oil chamber including the first pressure-receiving surface and a second oil chamber including the second pressure-receiving surface communicate with each other in the oil chamber in a state of having a difference in the hydraulic pressure via the radial clearance, and a hydraulic pressure of the first oil chamber is higher than a hydraulic pressure of the second oil chamber, and
when the stroke amount of the piston is larger than the specified amount, the first oil chamber and the second oil chamber communicate with each other with no difference in the hydraulic pressure.

4. The power transmission apparatus according to claim 1, wherein
in a case where the stroke amount of the piston is the specified amount, the friction engagement device is brought into a slightly slipping state where drag torque is generated between the friction plates and the plates.

5. The power transmission apparatus according to claim 4 further comprising:
a stepped automatic transmission capable of establishing any of plural gear shift stages having different gear shift ratios by selectively engaging plural engagement devices, wherein
of the plural engagement devices provided in the automatic transmission, the engagement device that is coupled to a rotary member of an unloaded section not involved in power transmission at the time of establishing a specified gear shift stage is constructed of the friction engagement device, and
when the specified gear shift stage is established by the automatic transmission, the stroke amount of the piston becomes the specified amount, and the friction engagement device is brought into the slightly slipping state, the friction engagement device being provided on an unloaded section side of a coupling section where a rotary member of a loaded section involved in the power transmission meshes with the rotary member of the unloaded section.
